(19) United States
(12) Patent Application Publication
(10) Pub. No.: US 2011/0146401 A1
(43) Pub. Date: Jun. 23, 2011

(54) ANGULAR VELOCITY SENSOR AND ELECTRONIC APPARATUS

(75) Inventors: Teruo Inaguma, Miyagi (JP); Junichi Honda, Miyagi (JP); Takanori Aoto, Miyagi (JP); Koki Hino, Miyagi (JP); Kazuo Takahashi, Miyagi (JP); Hiroshi Onuma, Miyagi (JP)

(73) Assignee: Sony Corporation, Tokyo (JP)

(21) Appl. No.: 12/968,700

(22) Filed: Dec. 15, 2010

(30) Foreign Application Priority Data
Dec. 22, 2009 (JP) P2009-290504

(51) Int. Cl. G01C 19/56

(52) U.S. Cl. 73/504.12

(57) ABSTRACT

Provided is an angular velocity sensor including a first vibration element, a second vibration element, and a support substrate. The first vibration element detects a first angular velocity about an axis parallel to a first direction. The second vibration element detects a second angular velocity about an axis parallel to a second direction obliquely intersecting with the first direction, and generates an output signal corresponding to a third angular velocity about an axis parallel to a third direction orthogonal to the first direction. The support substrate supports the first vibration element and the second vibration element.

### BACKGROUND OF THE INVENTION

1. Field of the Invention

The present invention relates to an angular velocity sensor and an electronic apparatus that are used for detecting camera shake in a video camera, movements in a virtual reality apparatus, and directions in a car navigation system, for example.

2. Description of the Related Art

As angular velocity sensors for consumer use, vibratory gyroscopes are widely used. A vibratory gyroscope detects an angular velocity by vibrating a vibrator at a predetermined frequency and detecting Coriolis force generated in the vibrator with use of a piezoelectric element or the like. The gyroscope above is incorporated in electronic apparatuses such as a video camera, a virtual reality apparatus, and a car navigation system, each of which is used as a sensor for detecting camera shake, movements, directions, or the like.

In a case where this type of gyroscope is used for detecting a change in posture in a space, there is known a structure in which gyroscopes are disposed along biaxial or triaxial directions orthogonal to each other. For example, Japanese Patent Application Laid-open No. 2000-283765 (paragraph [0019], FIG. 8; hereinafter, referred to as Patent Document 1) discloses a three-dimensional angular velocity sensor in which three tripod-tuning-fork vibrators are disposed on the base so as to be orthogonal to each other in triaxial directions.

### SUMMARY OF THE INVENTION

In recent years, along with the downsizing of electronic apparatuses, the downsizing and thinning of electronic parts incorporated in the electronic apparatuses are demanded. However, in the structure of Patent Document 1, two vibrators are disposed such that longitudinal directions thereof are orthogonal to each other in order to detect angular velocities in biaxial directions. For that reason, a mounting area for those vibrators is made larger, which make it difficult to achieve the downsizing of the sensor. Further, to detect angular velocities in triaxial directions, three vibrators are disposed so as to be orthogonal to each other, one of which is disposed with a longitudinal direction thereof pointing in a perpendicular direction (thickness direction). Therefore, there arises a problem that the thickness dimension of the sensor is increased, and the thinning thereof is difficult to be achieved.

In view of the circumstances as described above, it is desirable to provide an angular velocity sensor and an electronic apparatus that are capable of realizing the thinning or downsizing of the sensor.

According to an embodiment of the present invention, there is provided an angular velocity sensor including a first vibration element, a second vibration element, and a support substrate.

The first vibration element detects a first angular velocity about an axis parallel to a first direction.

The second vibration element detects a second angular velocity about an axis parallel to a second direction obliquely intersecting with the first direction. The second vibration element is for generating an output signal corresponding to a third angular velocity about an axis parallel to a third direction orthogonal to the first direction.

The support substrate supports the first vibration element and the second vibration element.

In the angular velocity sensor, the output signal corresponding to the third angular velocity can be calculated by simple calculation using a trigonometric function based on a detection signal of the first angular velocity by the first vibration element and a detection signal of the second angular velocity by the second vibration element. The third direction may be a direction orthogonal to the first direction on a first plane to which the first direction and the second direction belong. With this structure, it is possible to reduce a mounting area for the vibration elements on the support substrate, which are necessary for detecting the angular velocities in the biaxial directions orthogonal to each other on the plane to which the first direction and the second direction belong, with the result that the downsizing of the angular velocity sensor can be achieved. Further, in a case where the plane is parallel to the thickness direction of the sensor, the thinning of the sensor can be achieved.

The phrase “second direction obliquely intersecting with the first direction” means that the first direction and the second direction are not orthogonal to each other. Specifically, when an angle formed by the first direction and the second direction is denoted by θ, the range of θ is set to 0≦θ≦90 degrees, or 90 degrees≦θ≦180 degrees. The angle θ can be set as appropriate in accordance with the size, thickness, sensitivity, or the like of a sensor requested.

The structure of the first to third vibration elements is not particularly limited, and a vibration element including a cantilever-shaped tuning fork-type vibrator or a vibration element including a sound piece-type vibrator with a plurality of nodes may be possible. Further, in the case of the sound piece-type vibrator, the number of beams is also not limited and may be one, two, or three or more. The cross-section shape of the beam may be a polygon (quadratic prism shape or triangular prism shape) or a circle (columnar shape) in any case of the tuning fork-type vibrator and the sound piece-type vibrator. In addition, the structure is also applicable to vibration elements other than the tuning fork-type vibration element and the sound piece-type vibration element. Also in this case, the effect equal to that of the description above can be obtained.

The support substrate may have a first surface parallel to the first direction, on which the first vibration element and the second vibration element are mounted. With this structure, the mounting with the first surface of the support substrate as a reference can be performed, with the result that the reliability on the mounting of the first vibration element can be improved.

The first surface may be on a second plane orthogonal to the first plane. With this structure, the dimension of the support substrate in the thickness direction can be reduced, as compared to a case where detection axes of the vibration elements are arranged in axial directions orthogonal to each other.

In this case, the angular velocity sensor may further include a third vibration element to detect a fourth angular velocity about an axis parallel to a fourth direction orthogonal to the first plane. With this structure, it is possible to output a signal corresponding to angular velocities in triaxial directions orthogonal to each other.

The third vibration element may be mounted on the first surface of the support substrate. With this structure, it is possible to achieve the thinning of an angular velocity sensor in which first, second, and third vibration elements are mounted on a common substrate.

In the above structure, the support substrate may include a fixation portion in the first surface, the fixation portion positioning the second vibration element on a detection axis along the second direction. With this structure, it is possible to stably mount the second vibration element on the first surface.

According to another embodiment of the present invention, there is provided an electronic apparatus including a first vibration element, a second vibration element, a support substrate, and a signal processing circuit.

The first vibration element detects a first angular velocity about an axis parallel to a first direction.

The second vibration element detects a second angular velocity about an axis parallel to a second direction obliquely intersecting with the first direction.

The support substrate supports the first vibration element and the second vibration element.

The signal processing circuit generates an output signal corresponding to a third angular velocity about an axis parallel to a third direction orthogonal to the first direction, based on a signal related to the first angular velocity detected by the first vibration element and a signal related to the second angular velocity detected by the second vibration element.

As described above, according to the embodiments of the present invention, it is possible to achieve the thinning or downsizing of an angular velocity sensor.

These and other objects, features and advantages of the present invention will become more apparent in light of the following detailed description of best mode embodiments thereof, as illustrated in the accompanying drawings.

### BRIEF DESCRIPTION OF DRAWINGS

FIG. 1 is a schematic plan view showing a main portion of an angular velocity sensor according to a first embodiment of the present invention;

FIG. 2 is a side view of the whole of the angular velocity sensor of FIG. 1;

FIG. 3 is a plan view of a vibration element used in the angular velocity sensor of FIG. 1;

FIG. 4 is a cross-sectional view taken along the line A-A of FIG. 3;

FIG. 5 is a side view of a vibration element that detects an angular velocity about a Z′-axis direction in the angular velocity sensor of FIG. 1;

FIG. 6 is a side view of a vibration element showing a modified example of the structure of FIG. 5;

FIG. 7 is a schematic diagram for explaining an operation method for an angular velocity about a Z-axis direction in the angular velocity sensor of FIG. 1;

FIG. 8 is a diagram showing the mounting angle dependency of the vibration element on a level of low profile mounting of the vibration element and detection sensitivity about a Z axis in the angular velocity sensor of FIG. 1;

FIG. 9 is a block diagram showing a signal processing circuit that generates an angular velocity signal based on an output signal of the angular velocity sensor of FIG. 1;

FIG. 10 is a schematic plan view showing a main portion of an angular velocity sensor according to a second embodiment of the present invention;

FIG. 11 is a side view of a vibration element that detects an angular velocity about a Z′-axis direction in the angular velocity sensor of FIG. 10;

FIG. 12 is a schematic plan view showing a main portion of an angular velocity sensor according to a third embodiment of the present invention;

FIG. 13 is a side view of a vibration element that detects an angular velocity about a Z′-axis direction in the angular velocity sensor of FIG. 12;

FIG. 14 is a plan view showing a main portion of a support substrate in the angular velocity sensor of FIG. 12;

FIG. 15 is a cross-sectional view showing a main portion of an electric connection structure between the support substrate and the vibration element shown in FIG. 13;

FIG. 16 is a diagram for explaining a method of producing the angular velocity sensor of FIG. 12;

FIG. 17A is a schematic plan view showing a main portion of an angular velocity sensor according to a fourth embodiment of the present invention, and FIG. 17B is a schematic plan view showing a main portion of an angular velocity sensor shown as a comparative example;

FIG. 18 are schematic structural views showing a modified example of the angular velocity sensor according to the first embodiment of the present invention, in which FIG. 18A is a plan view and FIG. 18B is a side view;

FIG. 19 are schematic structural views showing another modified example of the angular velocity sensor according to the first embodiment of the present invention, in which FIG. 19A is a plan view and FIG. 19B is a side view; and

FIG. 20 are schematic structural views showing a modified example of the angular velocity sensor according to the fourth embodiment of the present invention, in which FIG. 20A is a plan view and FIG. 20B is a side view.

### DESCRIPTION OF PREFERRED EMBODIMENTS

Hereinafter, embodiments of the present invention will be described with reference to the drawings.

### First Embodiment

### Overall Structure

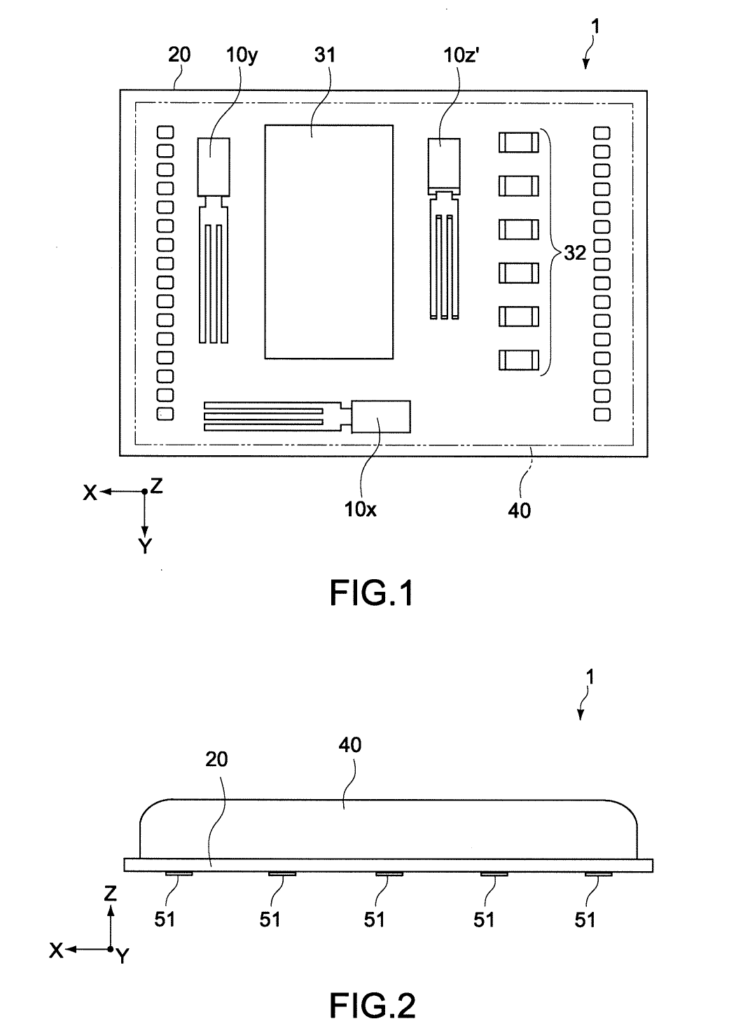

FIG. 1 is a schematic plan view showing an angular velocity sensor according to a first embodiment of the present invention. FIG. 2 is a side view of the angular velocity sensor provided with a cap. As shown in FIG. 1, assuming that three axes orthogonal to one another are an X axis, a Y axis, and a Z axis, an angular velocity sensor 1 of this embodiment has a horizontal direction in the X-axis direction, a vertical direction in the Y-axis direction, and a thickness direction in the Z-axis direction (front-rear direction of plane of FIG. 1).

The angular velocity sensor 1 includes three vibration elements 10x, 10y, and 10z′ and a support substrate 20. The vibration element 10x detects a rotating angular velocity about an axis parallel to the X axis, and the vibration element 10y detects a rotating angular velocity about an axis parallel to the Y axis. The vibration element 10z′ detects a rotating angular velocity about an axis parallel to a direction obliquely intersecting with the Y axis on the YZ plane (hereinafter, referred to as Z′ axis). The support substrate 20 supports those vibration elements 10x, 10y, and 10z′ in common.

The front surface of the support substrate 20 is formed to be parallel to the XY plane to which the X axis and the Y axis belong. The support substrate 20 is constituted of a circuit substrate in which a wiring pattern is formed on a surface of an insulating layer, as in a case of a printed circuit board. The structure of the support substrate 20 is not particularly limited. For example, the support substrate 20 is constituted of a multilayer wiring substrate including an insulating ceramics base material, wiring layers formed on front and back surfaces thereof, and a via electrically connecting those wiring layers between layers.

The angular velocity sensor 1 includes a driver circuit to drive the vibration elements 10x, 10y, and 10z′. The driver circuit is constituted of an IC chip 31, various passive parts 32 such as a chip capacitor and a chip resistor, and the like, and those electronic parts are mounted on the support substrate 20 together with the vibration elements 10x, 10y, and 10z′.

The angular velocity sensor 1 further includes a cap 40. The cap 40 covers the surface of the support substrate 20 and shields a mounting space for the vibration elements 10x, 10y, and 10z′ and the like from the outside. The cap 40 is formed of, for example, a metal material such as aluminum.

On the back surface side of the support substrate 20, formed are a plurality of external connection terminals 51 that are electrically connected to the wiring layer on the front surface of the support substrate 20. The angular velocity sensor 1 is mounted on a control substrate (not shown) of an electronic apparatus via those external connection terminals 51. As the electronic apparatus, for example, a digital still camera or a digital video camera corresponds. In this case, the angular velocity sensor 1 serves as a camera shake detection sensor.

[Vibration Element]

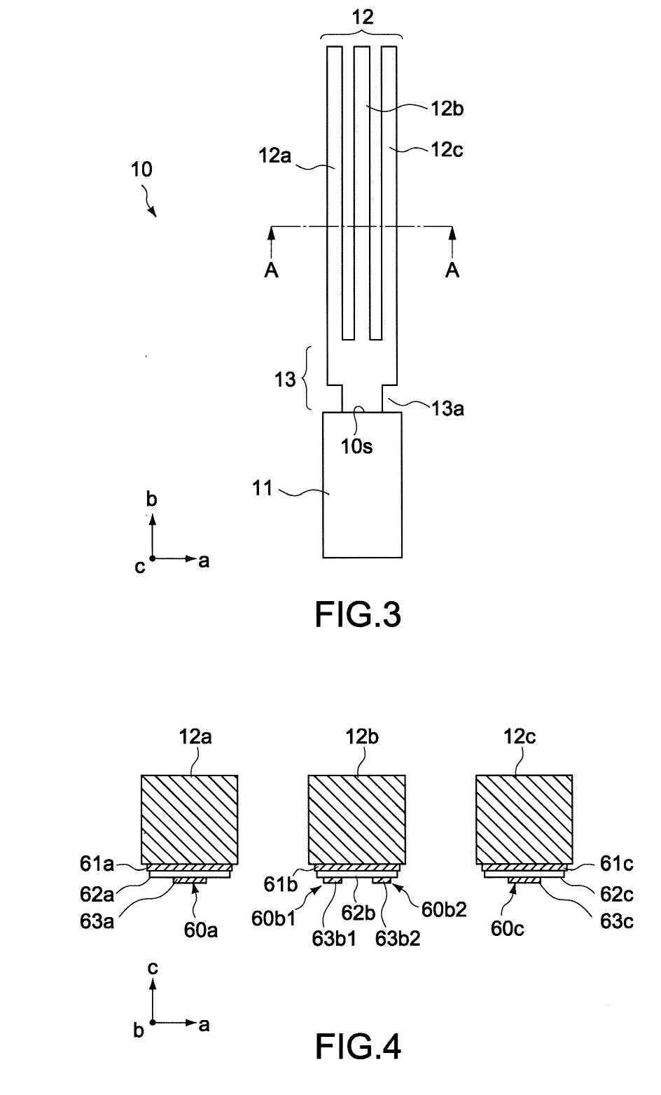

The vibration elements 10x, 10y, and 10z′ each have the same structure. FIG. 3 is a plan view of the vibration elements 10x, 10y, and 10z′. FIG. 4 is an enlarged cross-sectional view taken along the line A-A of FIG. 3. Hereinafter, the structure of the vibration elements 10x, 10y, and 10z′ will be described with reference to FIGS. 3 and 4. It should be noted that in the following description, the vibration elements 10x, 10y, and 10z′ are collectively referred to as “vibration element 10” except for the case where the vibration elements 10x, 10y, and 10z′ are individually described. In addition, in FIGS. 3 and 4, a width direction of the vibration element 10 is set as an a-axis direction, a length direction (detection axis direction) of the vibration element 10 is set as a b-axis direction, and a thickness direction of the vibration element 10 is set as a c-axis direction, and the a axis, the b axis, and the c axis are orthogonal to one another. It should be noted that in this embodiment, the vibration elements each have the same structure, but vibration elements having different structures may be used.

The vibration element 10 includes a base 11 fixed to the front surface of the support substrate 20, a vibrator 12 that is vibrated at a predetermined resonant frequency, and a coupling portion 13 that couples the base 11 and the vibrator 12. Those base 11, vibrator 12, and coupling portion 13 are integrally formed, and for example, formed by processing a monocrystalline silicon substrate into a predetermined shape.

The vibrator 12 has three vibration beams 12a, 12b, and 12c. The vibration beams 12a to 12c are coupled by the coupling portion 13. The vibration beams 12a to 12c are arrayed at constant intervals in the a-axis direction, and an extension direction thereof (b-axis direction) is the X-axis direction as to the vibration element 10x, the Y-axis direction as to the vibration element 10y, and the Z′-axis direction as to the vibration element 10z′.

The coupling portion 13 has a width equal to that of the base 11, and supports the vibration beams 12a to 12c within a width dimension equal to that of the base 11. The coupling portion 13 may have a constriction 13a for suppressing the vibration of the vibration beams 12a to 12c from being propagated to the base 11.

The size of the vibration element 10 is not particularly limited. In this embodiment, the total length of the element is 3 mm, the total width thereof is 500 μm, the thickness of the vibration beams 12a to 12c is 100 μm, the length of the vibration beams 12a to 12c is 1.8 to 1.9 mm, the width of the vibration beams 12a to 12c is 100 μm, and the thickness of the base 11 is 400 μm.

The vibration element 10 has a mounting surface 10a, through which the vibration element 10 is mounted on the support substrate 20. The base 11, the vibrator 12, and the coupling portion 13 form a continuous flat surface on the mounting surface 10a side. A non-mounting surface of the element on the opposite side of the mounting surface 10a has a step 10s, and with this step 10s as a boundary, the thickness of the base 11 side and that of the vibrator 12 side are different from each other. In this embodiment, the thickness of the base 11 is formed to be larger than that of the coupling portion 13 and the vibrator 12, but may be formed to be the same without forming the step 10s.

On the mounting surface 10a of the vibration element 10, drive electrodes that vibrate the vibrator 12, detection electrodes that detect vibration components derived from Coriolis force acting on the vibrator 12, and a plurality of terminals for electrically connecting the drive electrodes and the detection electrodes to the support substrate 20.

As shown in FIG. 4, on the surfaces of the vibration beams 12a to 12c on the mounting surface 10a side, laminated structures of electrode layers and a piezoelectric layer are formed. In other words, on the surfaces of the vibration beam 12a and the vibration beam 12c located on the both end sides, lower electrode layers 61a and 61c, piezoelectric layers 62a and 62c, and upper electrode layers 63a and 63c are formed. The upper electrode layers 63a and 63c are formed at positions on axis lines of the vibration beams 12a and 12c, respectively, over a predetermined length. The lower electrode layers 61a and 61c are each connected to a reference potential, and the upper electrode layers 63a and 63c are each connected to an output terminal of an oscillation circuit that generates a drive signal (alternating-current voltage signal). The lower electrode layer 61a, the piezoelectric layer 62a, and the upper electrode layer 63a constitute a first drive electrode 60a that vibrates the vibration beam 12a in a perpendicular direction (c-axis direction), and the lower electrode layer 61c, the piezoelectric layer 62c, and the upper electrode layer 63c constitute a second drive electrode 60c that vibrates the vibration beam 12c in the perpendicular direction (c-axis direction).

Further, on the surface of the vibration beam 12b located at the center, a lower electrode layer 61b, a piezoelectric layer 62b, and upper electrode layers 63b1 and 63b2 are formed. The upper electrode layers 63b1 and 63b2 are formed at positions symmetric with respect to an axis line of the vibration beam 12b over a predetermined length. The lower electrode layer 61b is connected to a reference potential, and the upper electrode layers 63b1 and 63b2 are each connected to a signal processing circuit (not shown). The lower electrode layer 61b, the piezoelectric layer 62b, and the upper electrode layer 63b1 constitute a first detection electrode 60b1 that detects an angular velocity about the b axis, and the lower electrode layer 61b, the piezoelectric layer 62b, and the upper electrode layer 63b2 constitute a second detection electrode 60b2 that detects an angular velocity about the b axis.

In the vibration element 10 of this embodiment, when a drive signal of the same phase is input to the first and second drive electrodes 60a and 60c, due to the piezoelectric function of the piezoelectric layers 62a and 62c, the vibration beams 12a and 12c are vibrated in the c-axis direction. Due to the vibration of the vibration beams 12a and 12c, the vibration beam 12b at the center is also vibrated in the c-axis direction. At this time, the vibration beam 12b is vibrated at a phase opposite to that of the vibration beams 12a and 12c on the both end sides. It should be noted that it may be possible to dispose a drive electrode also on the surface of the vibration beam 12b located at the center, and vibrate the vibration beam 12b located at the center more positively at a phase opposite to that of the vibration beams 12a and 12c.

The first and second detection electrodes 60b1 and 60b2 generate a voltage corresponding to the deformation of the vibration beam 12b. The detection electrodes 60b1 and 60b2 generate an output voltage derived from the vibration of the vibration beam 12b to the c-axis direction, and output the voltage to the signal processing circuit described above. Here, when a rotating angular velocity is generated about the b axis, Coriolis force corresponding to the magnitude of the angular velocity acts on the vibrator 12. The orientation of the Coriolis force is the a-axis direction orthogonal to the c-axis direction, and the detection electrodes 60b1 and 60b2 detect vibration components along the a-axis direction of the vibration beam 12b.

The signal processing circuit described above generates a reference signal constituted of a sum signal of outputs of the detection electrodes 60b1 and 60b2, and feeds back the reference signal to the oscillation circuit that generates the drive signal. Further, when an angular velocity is generated, the detection voltages of the detection electrode 60b1 and the detection electrode 60b2 have opposite phases. The signal processing circuit described above generates a differential signal of both the electrodes, to thereby acquire an angular velocity signal including information on the magnitude and orientation of the angular velocity about the b axis.

It should be noted that the signal processing circuit described above may be included in the driver circuit on the support substrate 20, which is constituted of the IC chip 31 and the like, or may be structured on the control substrate of the electronic apparatus on which the angular velocity sensor 1 is mounted.

The vibration element 10 (10x, 10y, 10z′) structured as described above is mounted on the support substrate 20 as shown in FIG. 1. The vibration elements 10x, 10y, and 10z′ are disposed on the support substrate 20 such that the longitudinal directions (detection axes) of the vibrators 12 thereof are set towards the X axis, the Y axis, and the Z′ axis, respectively. Here, the vibration elements 10x and 10y are disposed such that the mounting surfaces 10a thereof are parallel to the surface of the support substrate 20. With this structure, the mounting of the vibration elements with the surface of the support substrate 20 as a reference is enabled, with the result that the reliability on the mounting of the vibration elements 10x and 10y can be enhanced.

Up to here the three tuning fork-type has been described in detail as an example. However, the shape (tuning fork-type, sound piece-type, etc.) of the vibrator as described above, the number of vibration pieces (one to multiple pieces), the structure of electrodes, the vibration drive direction and detection direction, and the like are not limited to the above case.

Further, in this embodiment, the vibration elements 10x and 10y are mounted by a flip chip method, with the mounting surfaces 10a thereof facing the support substrate 20. However, it may possible to bond the vibration elements to the support substrate with the mounting orientation of the vibration elements being set upside down, and make electrical connection by a wire bonding method.

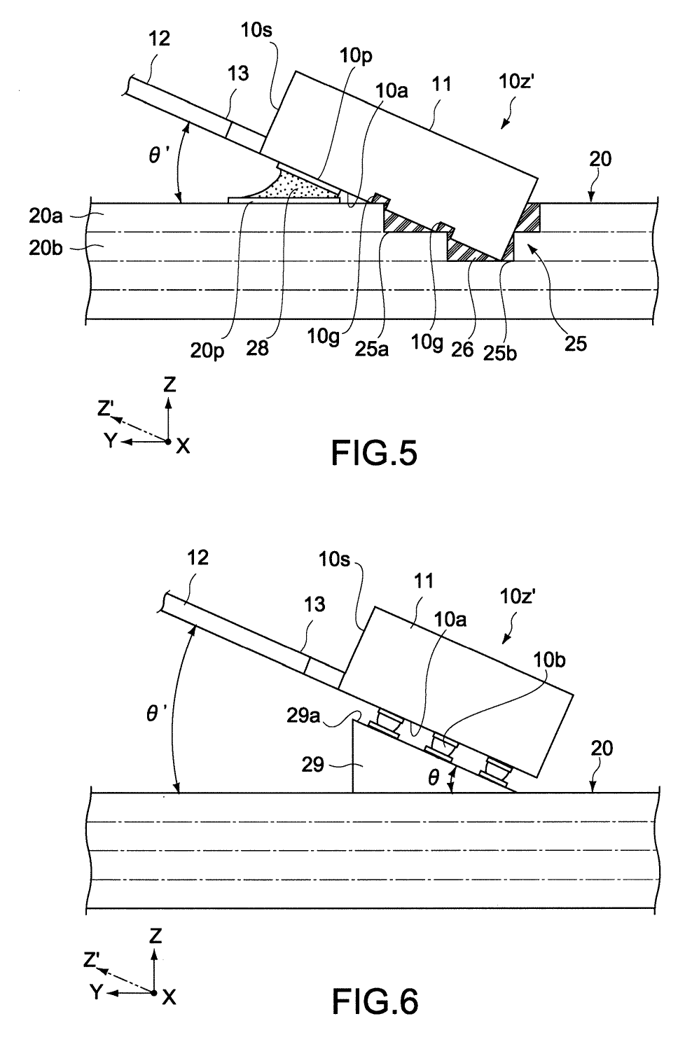

On the other hand, the vibration element 10z′ is fixed to be inclined by a predetermined angle θ with respect to the Y-axis direction so that the detection axis of the vibrator 12 points in the direction of the Z′ axis, and the angle θ is set to 0≦θ≦90 degrees or 90 degrees≦θ≦180 degrees. Accordingly, the detection axis of the vibrator 12 is fixed to be included upwardly by an angle θ′ formed with respect to the surface of the support substrate 20, and the angle θ′ is set to 0<θ′<90 degrees. The plane to which the Y-axis direction and the Z′-axis direction belong has a relationship orthogonal to the plane parallel to the surface of the support substrate 20. FIG. 5 is a cross-sectional side view of the vibration element 10z′ mounted on the support substrate 20. On the surface of the support substrate 20, formed is a recessed portion (fixation portion) 25 for positioning on the detection axis along the direction of the vibration element 10z′.

The angle θ′ is set as appropriate in accordance with the size, thickness, sensitivity, or the like of a sensor requested. In this embodiment, the angle θ′ is set to 15 degrees or more and 45 degrees or less. In this case, the angle θ is set to 15 degrees or more and 45 degrees or less, or 135 degrees or more and 165 degrees or less.

The support substrate 20 of this embodiment is constituted of a multilayer ceramics substrate. The recessed portion 25 is constituted of a multistep recessed portion including a first recessed portion 25a formed in a front surface layer 20a, and a second recessed portion 25b formed in a second layer 20b exposed from the first recessed portion 25a. The vibration element 10z′ is bonded to the recessed portion 25 via a non-conductive adhesive 26. When the size and depth of the first and second recessed portions 25a and 25b are adjusted as appropriate, the vibration element 10z′ can be positioned in a desired posture. In addition, when grooves 10g to be engaged with the steps of the first and second recessed portions 25a and 25b are formed in the base 11 of the vibration element 10z′, the highly precise positioning of the vibration element 10z′ to the recessed portion 25 is enabled.

The vibration element 10z′ is electrically connected to the support substrate 20 via a conductive bonding material 28 such as solder. In this case, an electrode pad 10p formed on the mounting surface side of the base 11 of the vibration element 10z′ is bonded to a land 20p formed on the support substrate 20 by the conductive bonding material 28. It should be noted that a wire bonding method using metal wires may be adopted with the vibration element upside down, instead of soldering.

The fixation portion that positions the detection axis of the vibration element 10z′ to the Z′-axis direction may be structured by a projected portion 29 formed on the surface of the support substrate 20 as shown in FIG. 6. In the example shown in FIG. 6, the projected portion 29 has, for example, an included surface 29a that is inclined by an angle θ with respect to the surface of the support substrate 20. On the included surface 29a, connection pads that communicate with the wiring layer of the support substrate 20 are formed, and the vibration element 10z′ is mounted to the connection pads via a plurality of bumps 10b.

[Method of Detecting Angular Velocity about Z Axis]

Next, a method of detecting an angular velocity with the angular velocity sensor 1 according to this embodiment will be described.

Each of the vibration elements 10x, 10y, and 10z′ on the support substrate 20 is vibrated at a predetermined resonant frequency when a drive signal is input to the drive electrodes 60a and 60c thereof (FIG. 4). The resonant frequency is set to, for example, 1 kHz or more and 100 kHz or less, but the resonant frequency may be set to 10 kHz or more and 50 kHz or less in the tuning fork-type vibration element. The resonant frequency is set to a frequency different from that of other parts used in an electronic apparatus in which the angular velocity sensor 1 is used. In addition, in order to suppress the interference between the vibration elements (crosstalk between detection axes), the resonant frequencies of the vibration elements are set to be different from each other by 1 kHz or more at minimum, and more desirably, by 2 kHz or more.

The resonant frequencies of the vibration elements can also be made higher by shortening the length of the beam portion. Therefore, when the resonant frequency of the vibration element 10z′ obliquely disposed is set to be highest, the height of the angular velocity sensor 1 can be suppressed to be lower, which is advantageous.

The vibration element 10x detects an angular velocity about an axis parallel to the X-axis direction. The vibration element 10y detects an angular velocity about an axis parallel to the Y-axis direction. The vibration element 10z′ detects an angular velocity about an axis parallel to the Z′ axis. The angular velocity sensor 1 of this embodiment outputs an angular velocity about an axis parallel to the Z axis by using the vibration element 10y and the vibration element 10z′.

Specifically, the angular velocity sensor 1 uses a detection signal of the vibration element 10z′ to output an angular velocity about the Z axis. At this time, the detection signal of the vibration element 10z′ includes a signal related to an angular velocity about an axis parallel to the Z axis and a signal related to an angular velocity about an axis parallel to the Y axis. In this regard, in this embodiment, the detection signal of the vibration element 10y is used to correct the detection signal of the vibration element 10z′, with the result that an angular velocity about an axis parallel to the Z axis is output.

Further, in the detection signal of the vibration element 10z′, the detection sensitivity with respect to the angular velocity about the Z axis is reduced as the inclination from the Z axis becomes larger, and an amount of the reduction is a function of sin θ. For example, in a case where an angle (θ′) formed by the Y-axis direction and the Z′-axis direction is 30 degrees, the detection sensitivity of the angular velocity about the Z axis is reduced to 50%. Accordingly, when an element having higher detection sensitivity (higher S/N ratio) than that of the other vibration elements 10x and 10y is used for the vibration element 10z′, the angular velocity about the Z axis can be detected with high sensitivity.

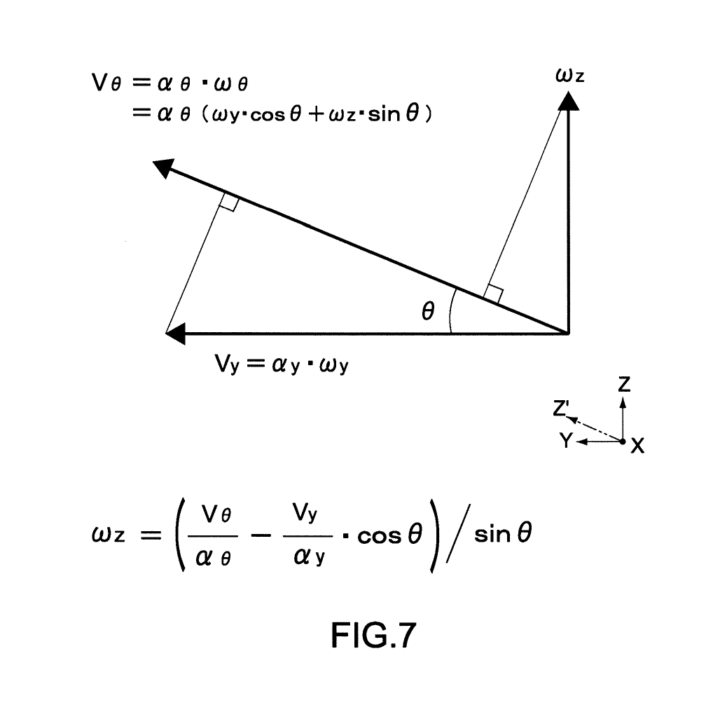

FIG. 7 is a diagram for explaining a method of detecting an angular velocity about the Z axis. Here, the angular velocity about the Z axis is represented as ωz, the angular velocity about the Y axis is represented as ωy, the angular velocity about the Z′ axis is represented as ωθ, the sensitivity of the vibration element 10y is represented as αy, the output of the vibration element 10y is represented as Vy, the sensitivity of the vibration element 10z′ is represented as αθ, and the output of the vibration element 10z′ is represented as Vθ(Vz′).

The outputs Vy and Vθ of the vibration elements 10y and 10z′ are represented in the following expressions.

Vy=αy·ωy (1)

Vθ=αθ·ωθ (2)

Further, ωθ is represented as follows using ωy and ωz.

ωθ=ωy·cos θ+ωz·sin θ (3)

When Expression (3) is represented using Expression (2), the following expressing is obtained.

Vθ=αθ(ωy·cos θ+ωz·sin θ) (4)

When the terms of Expression (4) are rearranged, the following expression is obtained.

Vθ−αθ·ωy−cos θ=αθ·ωz−sin θ

Using Expression (1), obtained is the following expression.

Vθ−(αθ/αy)·Vy·cos θ=αθ·ωz·sin θ

Therefore, ωz is expressed as follows.

ωz={(Vθ/αθ)−(Vy/αy)·cos θ}/sin θ (5)

When the sensitivity αθ and the sensitivity αy are equal to each other, an output (Vz) corresponding to an angular velocity about the Z axis based on the output Vy of the vibration element 10y and the output Vθ of the vibration element 10z′ is as follows.

Vz=(Vθ−Vy·cos θ)/sin θ (5)

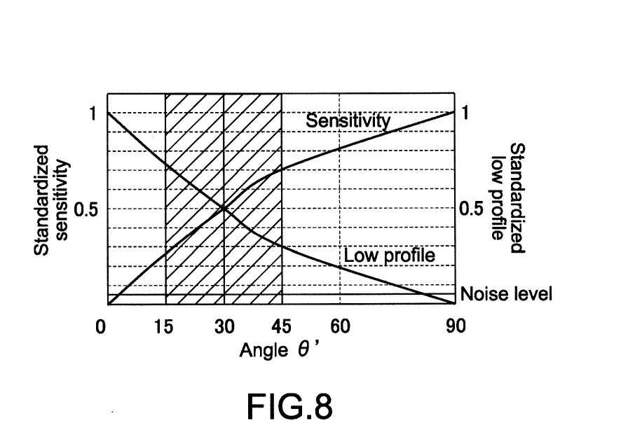

FIG. 8 shows the mounting angle (0≦θ′≦90 degrees) dependency of the vibration element 10z′ on a level of low profile mounting of the vibration element 10z′ and the detection sensitivity of ωz. In the detection sensitivity of the vertical axis, sensitivity at θ′=90 degrees is standardized to 1, and in the low profile mounting, a level of low profile at θ′=0 degree is standardized to 1. As shown in FIG. 8, as the angle θ′ becomes closer to 90 degrees (as the angle becomes more perpendicular to the surface of the support substrate), the detection sensitivity becomes higher, but the level of low profile mounting is lowered (that is, the height dimension becomes larger). With θ′≦45 degrees, the vibration element z′ can be reduced in profile by 30% or more as compared to a case where the vibration element z′ is installed in the perpendicular direction. Further, with θ′≦30 degrees, the thickness of the sensor including the cap 40 can be suppressed to a desirable range of 2 mm or less. In the case of θ′=30±5 degrees, both the detection sensitivity and the level of low profile mounting can be set to be approximately half the maximum values. As the mounting angle θ′ becomes smaller, the effect of reduction in profile is improved. However, when the fact that a noise level is constant irrespective of the angle is taken into consideration, it is desirable to set the detection sensitivity to a range not falling below ¼ of a maximum value thereof, and a minimum value of θ at this time is 15 degrees.

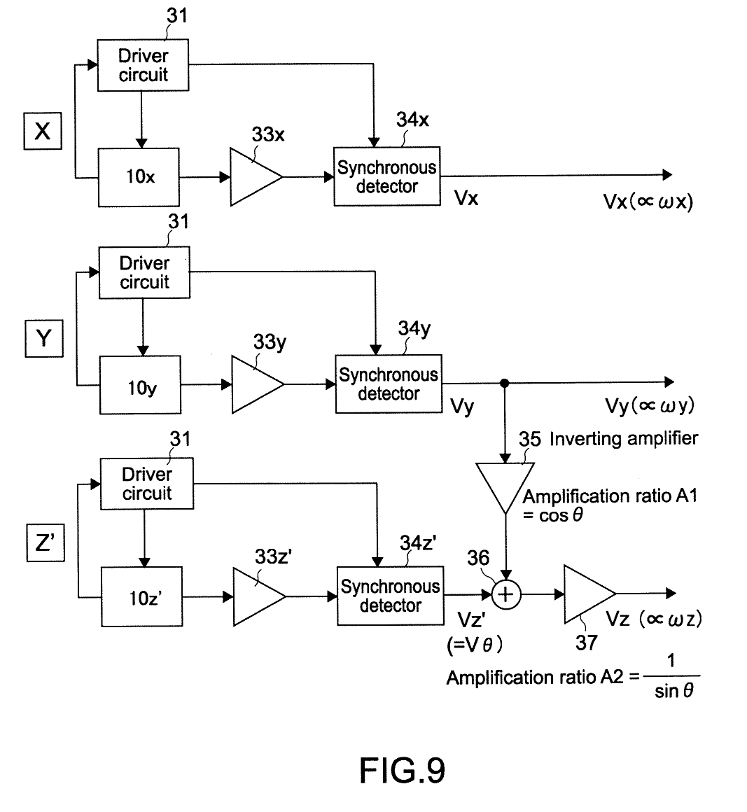

Next, FIG. 9 is a block diagram showing an example of the signal processing circuit for generating output signals Vx, Vy, and Vz corresponding to the angular velocities ωx, ωy, and ωz, respectively. Each of the vibration elements 10x, 10y, and 10z′ receives a drive signal from a driver circuit (oscillation circuit) 31 and is driven at a predetermined frequency. Outputs of the vibration elements 10x, 10y, and 10z′ are amplified by amplifiers 33x, 33y, and 33z′, respectively, and then supplied to synchronous detectors 34x, 34y, and 34z′, respectively. The synchronous detectors 34x, 34y, and 34z′ full-wave rectify the amplified signals in synchronization with the output of the drive signals from the driver circuits 31, and extract output signals Vx, Vy, and Vz corresponding to angular velocities ωx, ωy, and ωz, respectively.

Here, in the angular velocity output signal Vz, as represented in Expression (5) or (5)′, the output of the vibration element 10z′ is corrected by the output of the vibration element 10y. In the circuit example shown in FIG. 9, the output (−Vy·cos θ) inverting-amplified in an inverting amplifier 35 at an amplification ratio of A1=cos θ is supplied to an adder 36. The adder 36 adds the above-mentioned output and the output of the vibration element 10z′ (Vz′=Vθ), and outputs the resulting output signal (Vθ−Vy·cos θ) to an amplifier 37. The amplifier 37 amplifies the output at an amplification ratio of A2(1/sin θ), to thereby output a signal Vz corresponding to an angular velocity ωz about the Z axis shown in Expression (5).

According to the angular velocity sensor 1 of this embodiment structured as described above, the detection axis of the vibration element 10z′ for outputting an angular velocity about an axis parallel to the Z axis is arranged in an oblique direction inclined with respect to the Z-axis direction. Accordingly, the thickness dimension of the angular velocity sensor 1 along the Z-axis direction can be reduced.

Further, according to this embodiment, it is possible to structure a triaxial angular velocity sensor capable of detecting angular velocities about X, Y, and Z axes orthogonal to one another. With this structure, a multifunctional angular velocity sensor can be achieved.

In addition, the angular velocity sensor according to this embodiment is incorporated in electronic apparatuses such as a digital still camera, a video camera, a virtual reality apparatus, and a car navigation system, and is used as sensor parts for detecting camera shake, movements, directions, and the like. Particularly, according to this embodiment, the sensor can be downsized and thinned, with the result that it is also possible to meet the demand for the downsizing, thinning, or the like of the electronic apparatuses satisfactorily.

### Second Embodiment

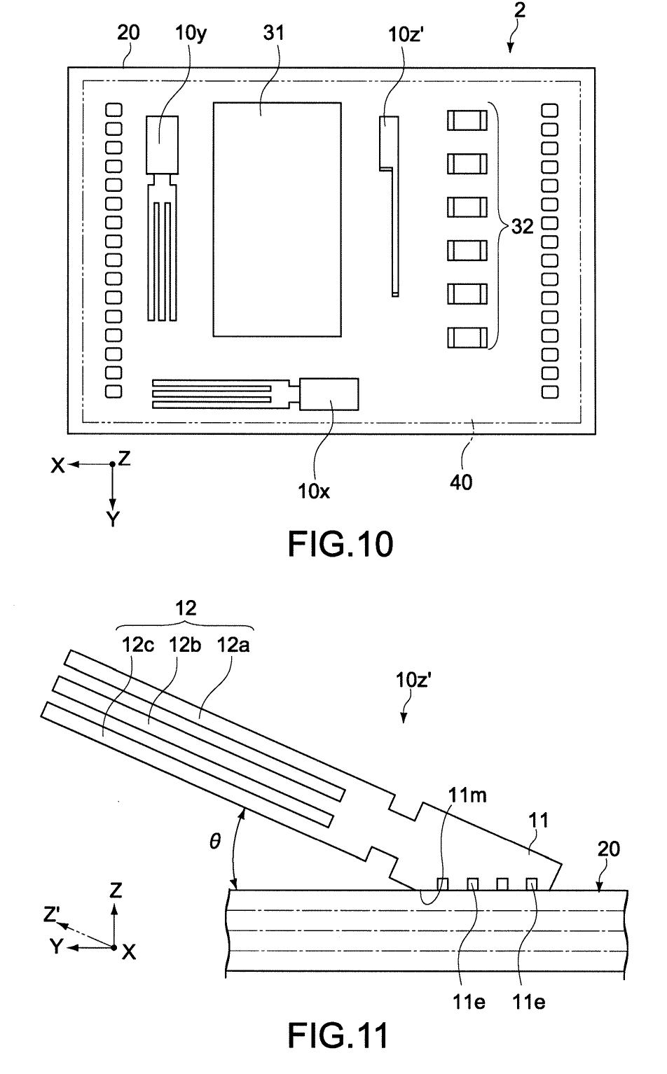

FIG. 10 is a schematic plan view showing an angular velocity sensor according to a second embodiment of the present invention, and FIG. 11 is a side view showing a main portion thereof. In FIGS. 10 and 11, portions corresponding to those of the first embodiment are denoted by the same reference symbols, and detailed description thereof will be omitted.

In an angular velocity sensor 2 of this embodiment, a vibration element 10z′ that detects an angular velocity about an axis parallel to a Z′ axis is mounted on a support substrate 20 such that an arrangement direction of vibration beams 12a to 12c thereof belongs to a plane perpendicular to the surface of the support substrate 20. A mounting surface 11m is formed on a base 11 of the vibration element 10z′ such that an extension direction of the vibration beams 12a to 12c in the state mounted on the support substrate 20 is aligned with an axial direction parallel to the Z′ axis.

The mounting surface 11m is formed on one side of the base 11. The mounting surface 11m has a planar shape formed in a direction intersecting with the vibration beams 12a to 12c by an angle θ, and at a side edge portion thereof, a plurality of terminals 11e that are electrically bonded to a land portion of the support substrate 20 are formed. For the electrical connection between the land portion and the terminals 11e, conductive bonding materials such as solder and metal wires can be used. The mounting surface 11m can be bonded to the support substrate 20 with use of a non-conductive adhesive.

Also in the angular velocity sensor 2 of this embodiment structured as described above, the action and effect that are the same as those of the first embodiment are produced. Particularly, according to this embodiment, the bonding width of the base 11 with respect to the support substrate 20 is suppressed to the thickness dimension of the base 11, with the result that the mounting area for the vibration element 10z′ can be reduced as compared to the first embodiment.

### Third Embodiment

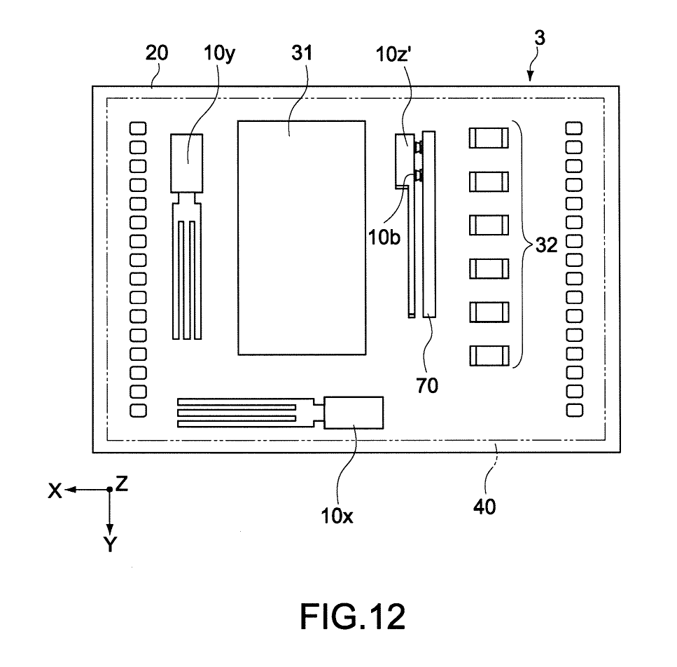

FIG. 12 is a schematic plan view showing an angular velocity sensor according to a third embodiment of the present invention. In FIG. 12, portions corresponding to those of the first embodiment are denoted by the same reference symbols, and detailed description thereof will be omitted.

In an angular velocity sensor 3 of this embodiment, as in the second embodiment described above, a vibration element 10z′ is mounted on a support substrate 20 such that an arrangement direction of vibration beams 12a to 12c thereof belongs to a plane perpendicular to the surface of the support substrate 20. The angular velocity sensor 3 of this embodiment is different from that of the second embodiment described above in the structure in which the vibration element 10z′ is fixed to the support substrate 20, and has an auxiliary board 70 that connects the vibration element 10z′ and the support substrate 20. The auxiliary board 70 supports the vibration element 10z′ such that an extension direction of the vibration beams 12a to 12c in the state mounted on the support substrate 20 is aligned with an axial direction parallel to a Z′ axis.

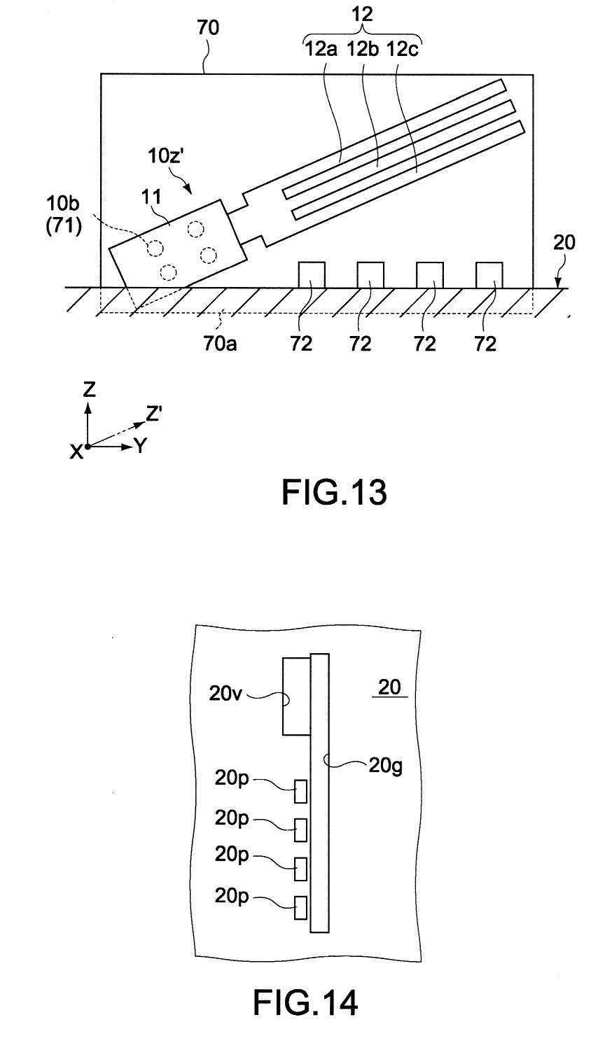

FIG. 13 is a side view of a main portion of the angular velocity sensor 3, showing the vibration element 10z′ mounted on the support substrate 20 via the auxiliary board 70. The auxiliary board 70 is constituted of a printed circuit board, similar to the support substrate 20. The auxiliary board 70 includes first terminals 71 electrically connected to the vibration element 10z′ and second terminals 72 electrically connected to the support substrate 20. The auxiliary board 70 is formed into a rectangular shape, but the shape is not limited thereto.

The vibration element 10z′ is mounted to the auxiliary board 70 by a flip chip method and is connected to the first terminals 71 via bumps 10b. Though not limited thereto, the vibration element 10z′ may be mounted on the auxiliary board 70 by a wire bonding method.

The auxiliary board 70 is connected to the surface of the support substrate 20 with a lower edge portion 70a thereof as a connection end portion. FIG. 14 is a plan view showing a surface area of the support substrate 20, to which the auxiliary board 70 is connected. In the surface of the support substrate 20, a connection groove 20g into which the connection end portion 70a of the auxiliary board 70 is fitted is formed. The connection groove 20g supports the auxiliary board 70 in a perpendicular direction with respect to the surface of the support substrate 20. In order to fix the connection end portion 70a to the connection groove 20g, for example, an adhesive can be used.

On the surface of the support substrate 20, a plurality of lands 20p electrically connected to the auxiliary board 70 are formed in the vicinity of the area where the connection groove 20g is formed. Further, as shown in FIG. 13, in a case where the vibration element 10z′ interferes with the surface of the support substrate 20 at a time when the auxiliary board 70 is connected, a clearance groove 20v that accommodates the base 11 of the vibration element 10z′ is formed adjacently to the connection groove 20g.

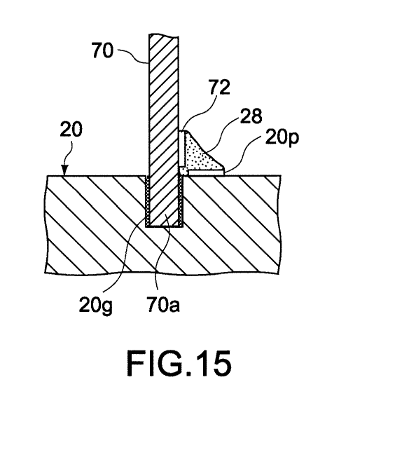

FIG. 15 is a cross-sectional view showing a main portion showing an electrical connection structure between the support substrate 20 and the auxiliary board 70. The second terminals 72 of the auxiliary board 70 are formed at positions corresponding to positions where the lands 20p are formed on the support substrate 20 when the auxiliary board 70 is connected to the support substrate 20. The second terminals 72 and the lands 20p are electrically connected to each other using a conductive bonding material 28 such as solder, as shown in FIG. 15.

In the angular velocity sensor 3 according to this embodiment structured as described above, after the vibration element 10z′ is mounted to the auxiliary board 70, the vibration element 10z′ is mounted on the support substrate 20 via the auxiliary board 70. After the auxiliary board 70 is completely connected to the support substrate 20, the second terminals 72 and the lands 20p are electrically connected.

According to this embodiment, the vibration element 10z′ can be mounted to the auxiliary board 70 on a plane, with the result that the reliability on the mounting of the vibration element 10z′ can be ensured. In addition, it is possible to stably obtain a predetermined inclined angle θ with respect to the support substrate 20. Furthermore, it is possible to handle the vibration element 10z′ as a unit substrate in which the vibration element 10z′ and the auxiliary board 70 are integrated.

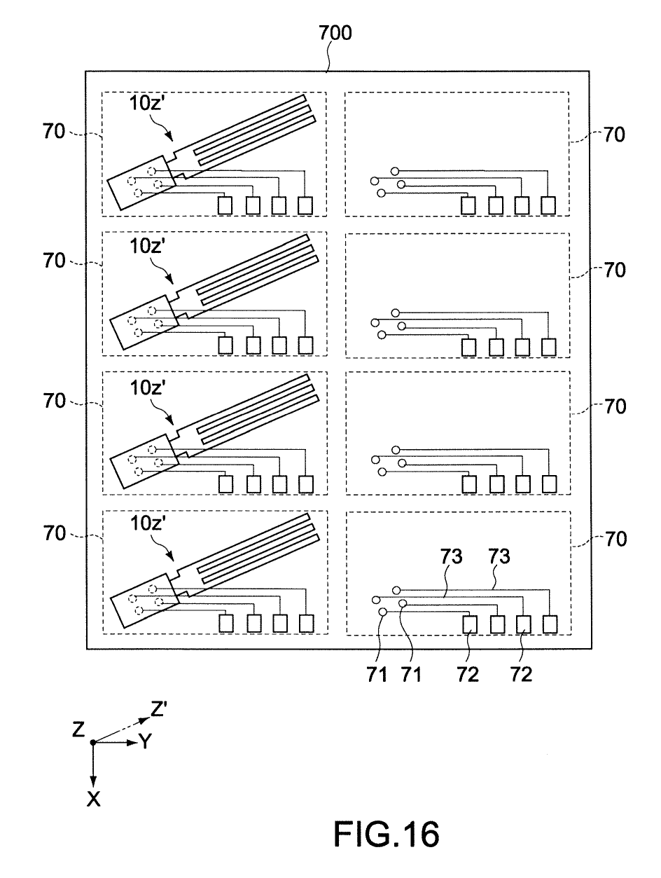

FIG. 16 is a plan view showing an example of a method of producing the unit substrate described above. The auxiliary board 70 is formed by being cut out from one mother substrate 700 into a predetermined shape. The mother board 700 is made of a large-size substrate from which a plurality of auxiliary boards 70 can be simultaneously formed.

As shown in FIG. 16, on the surface of the mother board 700, the first terminals 71, the second terminals 72, and wires 73 that connect the first terminals 71 and the second terminals 72 are formed in each area (cell area) cut out as an auxiliary board 70. The vibration element 10z′ is mounted to the first terminals 71 in each cell area by a flip chip method with use of a mounter (not shown). At this time, when the width direction of the mother board 700 is set to the Y-axis direction, the vibration element 10z′ can be mounted with the direction thereof pointing in the Z′-axis direction inclined by a predetermined angle (θ) with respect to the Y axis. After the vibration elements 10z′ are mounted to all the cell areas on the mother board 700, the mother board 700 is divided (cut out) into individual parts in a unit of a cell area. Accordingly, a plurality of unit substrates in each of which the vibration element 10z′ and the auxiliary board 70 are integrated are simultaneously formed.

As described above, with use of a large-size mother board 700, as compared to a case where a vibration element 10z′ is mounted to each piece of an auxiliary board 70, the operability on the mounting of the vibration element 10z′ can be enhanced, and the handleability can also be improved. Further, all the vibration elements 10z′ can be subjected to the final inspection on the mother board 700. In addition, the step of irradiating a vibrator with laser light to adjust a resonant frequency or a level of detuning of the vibration element (difference between vertical resonant frequency and horizontal resonant frequency) is performed as needed. In this case, this step can be performed individually on all the vibration elements on the mother board 700, with the result that the operability can be improved.

### Forth Embodiment

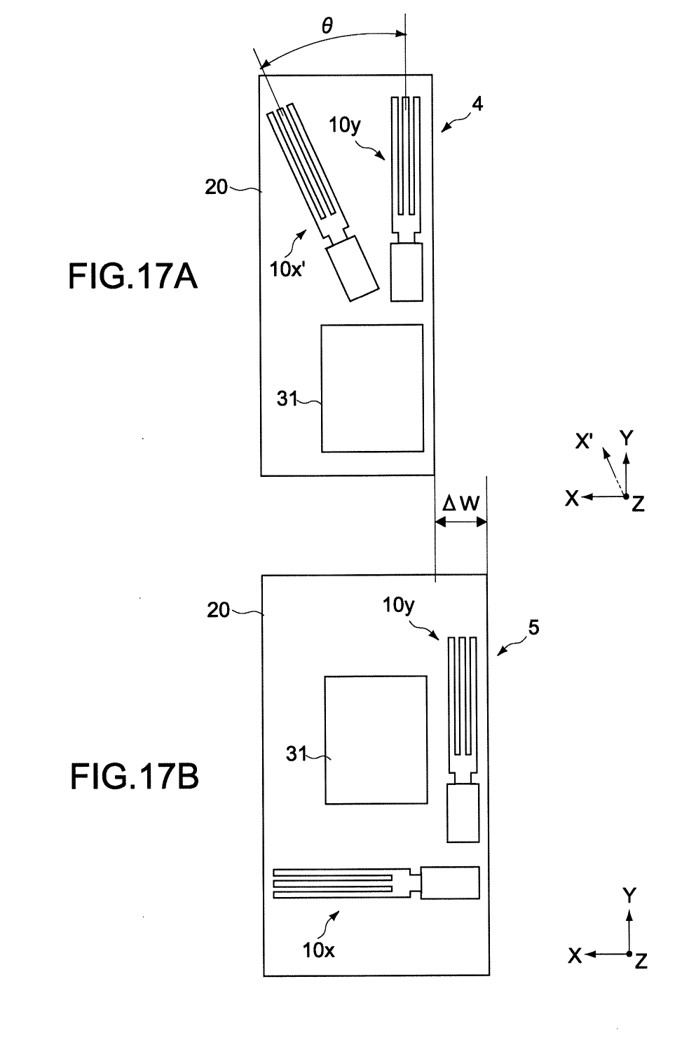

FIG. 17A is a schematic plan view of an angular velocity sensor according to a fourth embodiment of the present invention. It should be noted that in FIG. 17A, portions corresponding to those of the first embodiment are denoted by the same reference symbols, and detailed description thereof will be omitted.

An angular velocity sensor 4 of this embodiment is structured as a biaxial angular velocity sensor that detects angular velocities in biaxial directions of an X axis and a Y axis.

In the angular velocity sensor 4, two vibration elements 10x′ and 10y are mounted on the support substrate 20. The vibration element 10x′ has a detection axis in an X′-axis direction inclined by a predetermined angle θ with respect to the Y axis within an XY plane, and detects a rotating angular velocity about an axis parallel to the X′ axis. On the other hand, the vibration element 10y has a detection axis in the Y-axis direction, and detects a rotating angular velocity about an axis parallel to the Y axis. The angular velocity sensor 4 detects a rotating angular velocity about an axis parallel to the X axis based on a detection signal of the vibration element 10x′ and a detection signal of the vibration element 10y.

In this embodiment, a plane to which the X′ axis and the Y axis belong is formed to be parallel to the surface of the support substrate 20. Accordingly, an angular velocity ωx in the X-axis direction is calculated by the following expression, as in Expression (5).

ωx={(Vθ/αθ)−(Vy/αy)·cos θ}/sin θ (6)

Here, Vθ and Vy represent an output of the vibration element 10x′ and that of the vibration element 10y, respectively, and αθ and αy represent detection sensitivity of the vibration element 10x′ and that of the vibration element 10y, respectively.

According to this embodiment, it is possible to detect an angular velocity about an axis parallel to the X-axis direction without using a vibration element with a detection axis thereof pointing in the X-axis direction. Accordingly, it is possible to reduce a mounting area for vibration elements necessary for detecting angular velocities in biaxial directions. In addition, it is possible to make a width dimension of the support substrate 20 in the X-axis direction small.

For comparison, an angular velocity sensor 5 in which vibration elements are arranged in the X-axis direction and the Y-axis direction is shown in FIG. 17B. According to the angular velocity sensor 4 of this embodiment, the width dimension in the X-axis direction can be reduced by ΔW, as compared to the angular velocity sensor 5 according to the comparative example. Therefore, according to this embodiment, the downsizing of the angular velocity sensor can be achieved.

Heretofore, the embodiments of the present invention have been described, but the present invention is of course not limited thereto and can be variously modified based on the technical idea of the present invention.

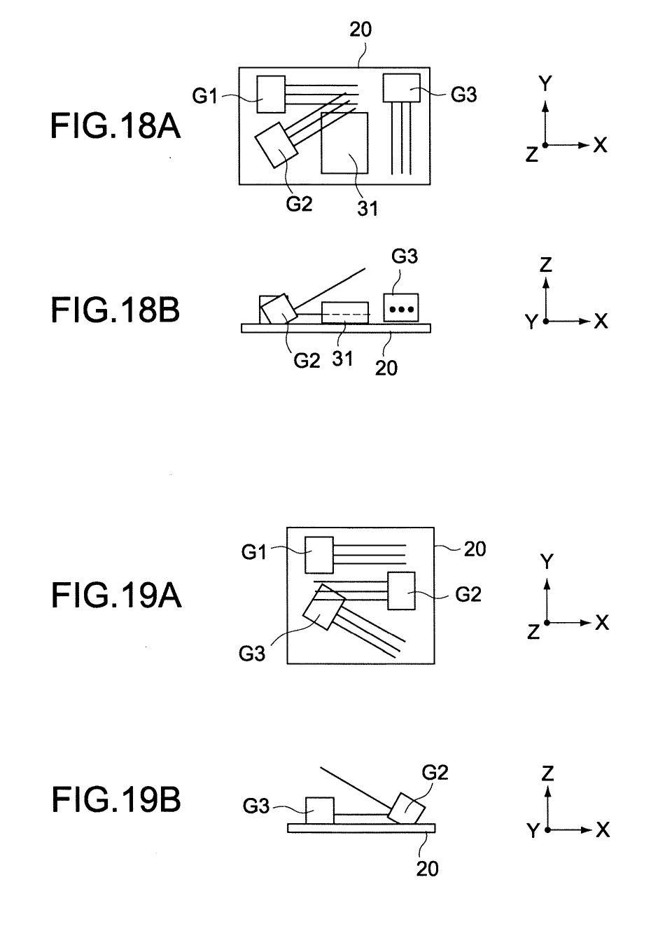

In the above embodiments, for example, as an angular velocity sensor to detect angular velocities in the triaxial directions, the vibration elements are disposed on the support substrate as shown in FIGS. 1, 10, and 12, but the angular velocity sensor is not limited thereto. It may possible to dispose vibration elements as shown in FIGS. 18 and 19.

In arrangement examples shown in FIGS. 18A and 18B, a vibration element G1 that detects an angular velocity about an axis parallel to an X-axis direction, a vibration element G2 that detects a signal for outputting an angular velocity about an axis parallel to a Z-axis direction, and a vibration element G3 that detects an angular velocity about an axis parallel to a Y-axis direction are provided. A detection axis of the vibration element G2 intersects with the X axis by a first predetermined angle with respect to the X axis on an XY plane, and intersects with the X axis by a second predetermined angle on an XZ plane. In this way, even in a case where the vibration element G2 is disposed and an IC chip is mounted at a part of a mounting area for the vibration element G2 accordingly, it is possible to dispose the vibration element G2 while avoiding the interference with the IC chip. Accordingly, the thinning and downsizing of the angular velocity sensor that detects angular velocities in the triaxial directions of the X, Y, and Z axes can be simultaneously achieved.

In arrangement examples shown in FIGS. 19A and 19B, a vibration element G1 that detects an angular velocity about an axis parallel to an X-axis direction, a vibration element G2 that detects a signal for outputting an angular velocity about an axis parallel to a Z-axis direction, and a vibration element G3 that detects a signal for outputting an angular velocity about an axis parallel to a Y-axis direction are provided. A detection axis of the vibration element G2 intersects with the X axis by a first predetermined angle on an XZ plane, and a detection axis of the vibration element G3 intersects with the X axis by a second predetermined angle on an XY plane. Accordingly, the angular velocity sensor that detects angular velocities in the triaxial directions of the X, Y, and Z axes can be structured.

In the arrangement examples of the vibration elements shown in FIGS. 18 and 19, the vibration elements are disposed so as to overlap each other when viewed from the Z-axis direction, with the result that the downsizing of the support substrate 20 is achieved. Of course, it may be possible to dispose the vibration elements such that the vibration elements do not overlap each other in the Z-axis direction.

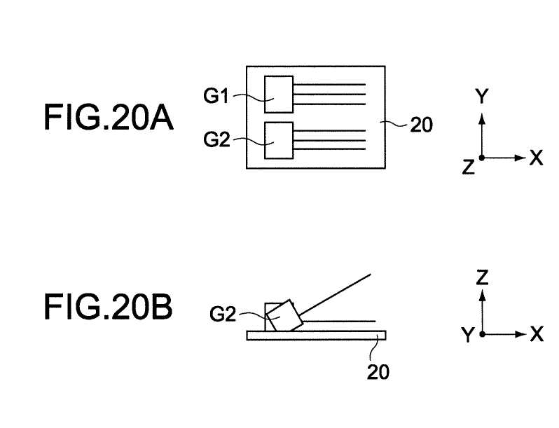

Further, in the embodiments described above, as an angular velocity sensor to detect angular velocities in the biaxial directions, the vibration elements are disposed on the support substrate as shown in FIG. 17A, but the angular velocity sensor is not limited thereto. It may be possible to dispose vibration elements as shown in FIG. 20. Specifically, in arrangement examples shown in FIGS. 20A and 20B, a vibration element G1 that detects an angular velocity about an axis parallel to an X-axis direction and a vibration element G2 that detects a signal for outputting an angular velocity about an axis parallel to a Z-axis direction are provided. A detection axis of the vibration element G2 intersects with the X axis by a predetermined angle on an XZ plane. Accordingly, the angular velocity sensor that detects angular velocities in the biaxial directions of X and Z axes can be structured.

On the other hand, in the embodiments described above, the three-tuning-fork type vibration element having three beams has been adopted as a vibration element. However, instead of such a vibration element, a tuning fork-type vibration element having one or two beams or more, a sound piece-type vibration element, or the like may be used.

In addition, in the first embodiment described above, the piezoelectric layers for drive and detection are formed on the mounting surface 10a side of the vibration element mounted on the support substrate 20, but the piezoelectric layers may be formed on a non-mounting surface side of the vibration element.

The present application contains subject matter related to that disclosed in Japanese Priority Patent Application JP 2009-290504 filed in the Japan Patent Office on Dec. 22, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An angular velocity sensor, comprising:
a first vibration element to detect a first angular velocity about an axis parallel to a first direction;
a second vibration element to detect a second angular velocity about an axis parallel to a second direction obliquely intersecting with the first direction, and generate an output signal corresponding to a third angular velocity about an axis parallel to a third direction orthogonal to the first direction; and
a support substrate to support the first vibration element and the second vibration element.

2. The angular velocity sensor according to claim 1,
wherein the third direction is orthogonal to the first direction on a first plane to which the first direction and the second direction belong.

3. The angular velocity sensor according to claim 2,
wherein the support substrate has a first surface parallel to the first direction, on which the first vibration element and the second vibration element are mounted.

4. The angular velocity sensor according to claim 3,
wherein the first surface is on a second plane orthogonal to the first plane.

5. The angular velocity sensor according to claim 4, further comprising
a third vibration element to detect a fourth angular velocity about an axis parallel to a fourth direction orthogonal to the first plane.

6. The angular velocity sensor according to claim 5,
wherein the third vibration element is mounted on the first surface of the support substrate.

7. The angular velocity sensor according to claim 4,
wherein the support substrate include a fixation portion in the first surface, the fixation portion positioning the second vibration element on a detection axis along the second direction.

8. The angular velocity sensor according to claim 7,
wherein the fixation portion is a recessed portion formed in the first surface, and
wherein the recessed portion is used for positioning the second vibration element in an inclined state with respect to the second direction.

9. The angular velocity sensor according to claim 7,
wherein the fixation portion includes
a groove formed in the first surface, and
an auxiliary board including a connection end portion fitted into the groove, the auxiliary board supporting the second vibration element in an inclined state with respect to the second direction.

10. The angular velocity sensor according to claim 1, further comprising
a third vibration element to detect a fourth angular velocity about an axis parallel to a fourth direction orthogonal to the first plane.

11. The angular velocity sensor according to claim 1,
wherein the first direction and the second direction forms an angle in one of a range of 15 degrees or more and 45 degrees or less and a range of 135 degrees or more and 165 degrees or less.

12. The angular velocity sensor according to claim 1,
wherein the first vibration element has a first detection sensitivity, and
wherein the second vibration element has a second detection sensitivity higher than the first detection sensitivity.

13. The angular velocity sensor according to claim 1,
wherein the support substrate further includes a second surface on which a plurality of external connection terminals for surface mounting to an external substrate are formed, the second surface being opposite to the first surface.

14. The angular velocity sensor according to claim 1,
wherein each of the first vibration element and the second vibration element includes
a vibrator,
a base that is fixed to the support substrate and supports the vibrator,
a drive portion that is formed on a surface of the vibrator and vibrates the vibrator, and
a detection portion that is formed on the surface of the vibrator and detects a vibration component derived from Coriolis force acting on the vibrator.

15. The angular velocity sensor according to claim 1, further comprising
a signal processing circuit to generate an output signal corresponding to the third angular velocity about the axis parallel to the third direction orthogonal to the first direction on a first plane to which the first direction and the second direction belong, based on a signal related to the first angular velocity detected by the first vibration element and a signal related to the second angular velocity detected to the second vibration element.

16. An electronic apparatus, comprising:
a first vibration element to detect a first angular velocity about an axis parallel to a first direction;
a second vibration element to detect a second angular velocity about an axis parallel to a second direction obliquely intersecting with the first direction;
a support substrate to support the first vibration element and the second vibration element; and
a signal processing circuit to generate an output signal corresponding to a third angular velocity about an axis parallel to a third direction orthogonal to the first direction, based on a signal related to the first angular velocity detected by the first vibration element and a signal related to the second angular velocity detected by the second vibration element.
